(19) United States
(12) Patent Application Publication
(10) Pub. No.: US 2013/0335687 A1
(43) Pub. Date: Dec. 19, 2013

(54) Display Panel, Method for Forming the Same, and Display System

(71) Applicant: Innolux Corporation, Chu-Nan (TW)

(72) Inventors: Hung-Ming SHEN, Chu-Nan (TW); Wan-Ling HUANG, Chu-Nan (TW); Kai-Neng YANG, Chu-Nan (TW); Tsau-Hua HSIEH, Chu-Nan (TW)

(21) Appl. No.: 13/915,275

(22) Filed: Jun. 11, 2013

(30) Foreign Application Priority Data
Jun. 14, 2012 (TW) 101121263
Apr. 19, 2013 (TW) 102113889

(51) Int. Cl. G02F 1/1337

(52) U.S. Cl. CPC G02F 1/133753; G02F 1/13378
USPC 349/126; 438/30

(57) ABSTRACT

An embodiment of the invention provides a display panel which includes: a first substrate; a second substrate disposed oppositely to the first substrate; a first alignment layer disposed overlying the first substrate; a second alignment layer disposed overlying the second substrate; and a liquid crystal layer disposed between the first alignment layer and the second alignment layer, wherein the first alignment layer is rubbing-aligned and disposed between the first substrate and the liquid crystal layer, and the second alignment layer is photo-aligned and disposed between the second substrate and the liquid crystal layer.

### CROSS REFERENCE TO RELATED APPLICATIONS

This Application claims priority of Taiwan Patent Application No. 101121263, filed on Jun. 14, 2012, and Taiwan Patent Application No. 102113889, filed on Apr. 19, 2013, the entirety of which is incorporated by reference herein.

### BACKGROUND OF THE INVENTION

1. Field of the Invention

The invention relates to display panels and methods for forming the same, and more specifically, to liquid crystal display panels and methods for forming the same.

2. Description of the Related Art

In liquid crystal display panels, the states of the alignment of liquid crystal molecules may affect spin and arrangement of the liquid crystal molecules in liquid crystal cells, and thus, have a major influence on the display quality of the liquid crystal display panels.

However, along with the continuous increase in display resolution, the problem of the alignment quality being degraded or process period being extended happens when using conventional alignment methods.

Thus, improved display panels and methods for forming the same are required for improving and/or solving the described problems.

### BRIEF SUMMARY OF THE INVENTION

An embodiment of the invention provides a display panel comprising a first substrate, a second substrate, a first alignment layer, a second alignment layer, and a liquid crystal layer. The second substrate is disposed oppositely to the first substrate. The first alignment layer is disposed overlying the first substrate. The second alignment layer is disposed overlying the second substrate. The liquid crystal layer is disposed between the first alignment layer and the second alignment layer. The first alignment layer is rubbing-aligned and disposed between the first substrate and the liquid crystal layer. The second alignment layer is photo-aligned and disposed between the second substrate and the liquid crystal layer.

In the display panel, it is preferred that a first pre-tilt angle of a liquid crystal molecule, which contacts the first alignment layer, in the liquid crystal layer is different from a second pre-tilt angle of a liquid crystal molecule, which contacts the second alignment layer, in the liquid crystal layer.

In the display panel, it is preferred that the first pre-tilt angle is between approximately 0 degree and approximately 3 degrees, and the second pre-tilt angle is between approximately 0 degree and approximately 1 degree.

In the display panel, it is preferred that the difference between the first pre-tilt angle and the second pre-tilt angle is between approximately 0.5 degree and approximately 2.5 degrees.

In the display panel, it is preferred that the display panel further comprises a protrusion disposed between the second substrate and the second alignment layer, wherein the protrusion is preferably at least 2 μm thick.

In the display panel, it is preferred that the second substrate comprises a plurality of pixel units, and that the protrusion is disposed in each of the pixel units, and a ratio of a footprint of the protrusion to an area of the pixel unit is 30% or greater.

In the display panel, it is preferred that each pixel unit further comprises a light transmission region and a light reflection region, and that a height difference between the light reflection region and the light transmission region is 2 μm or greater.

In the display panel, it is preferred that the display panel further comprises a spacer disposed between the first alignment layer and the second alignment layer.

In the display panel, it is preferred that the second substrate is a thin film transistor substrate.

In the display panel, it is preferred that the display panel further comprises a planarization layer disposed between the second alignment layer and the second substrate.

An embodiment of the invention provides a display system comprising a display device comprising a display panel. The display panel comprises a first substrate, a second substrate, a first alignment layer, a second alignment layer, and a liquid crystal layer. The second substrate is disposed opposite to the first substrate. The first alignment layer is disposed overlying a surface of the first substrate facing the second substrate. The second alignment layer is disposed overlying a surface of the second substrate facing the first substrate. The liquid crystal layer is disposed between the first alignment layer and the second alignment layer. The first alignment layer is rubbing-aligned, and the second alignment layer is photo-aligned.

An embodiment of the invention provides a method for forming a display panel. First, a first substrate is provided. Then, a rubbing-aligning process is performed on the first substrate to form a first alignment layer. Next, a second substrate is provided. Next, a photo-aligning process is performed on the second substrate to form a second substrate. Further, a liquid crystal layer is formed overlying the first alignment layer or the second alignment layer. Finally, the first substrate and the second substrate are oppositely disposed to sandwich the liquid crystal layer between the first alignment layer and the second alignment layer.

In the method for forming the display panel, it is preferred that a surface altitude difference of the second substrate is greater than that of the first substrate.

In the method for forming the display panel, it is preferred that the method further comprises a step of forming a planarization layer overlying the second substrate prior to the step of forming the second alignment layer overlying the second substrate.

In the method for forming the display panel, it is preferred that a first pre-tilt angle of a liquid crystal molecule, which contacts the first alignment layer, in the liquid crystal layer is different from a second pre-tilt angle of a liquid crystal molecule, which contacts the second alignment layer, in the liquid crystal layer.

In the method for forming the display panel, it is preferred that the first pre-tilt angle is between approximately 0 degree and approximately 3 degrees, and the second pre-tilt angle is between approximately 0 degree and approximately 1 degree.

In the method for forming the display panel, it is preferred that the difference between the first pre-tilt angle and the second pre-tilt angle is between approximately 0.5 degree and approximately 2.5 degrees.

In the method for forming the display panel, it is preferred that the method further comprises a step of forming a protrusion overlying the second substrate prior to the step of forming the second alignment layer, wherein the protrusion is preferably at least 2 μm high.

In the method for forming the display panel, it is preferred that the second substrate is a thin film transistor substrate.

In the method for forming the display panel, it is preferred that the method further comprises a step of forming a spacer between the first alignment layer and the second alignment layer.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1A through 1C show cross-sections at processing stages of a display panel of an embodiment of the invention;

FIG. 2 shows a cross-section a display panel of an embodiment of the invention;

FIG. 3A shows a cross-section a display panel of an embodiment of the invention;

FIG. 3B shows a cross-section a display panel of an embodiment of the invention;

FIG. 4 schematically shows of a display system of an embodiment of the invention;

FIGS. 5A through 5E show cross-sections at processing stages of a display panel of an embodiment of the invention; and

FIG. 6 shows a cross-section a display panel of an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Note that the concepts and specific practice modes of the invention are described in detail by the embodiments and the attached drawings. In the drawings or description, similar elements are indicated by similar reference numerals and/or letters. Further, the element shape or thickness in the drawings can be expanded for simplification or convenience of indication. Moreover, elements which are not shown or described can be in every form known by those skilled in the art.

It is understood that the following disclosure provides many different embodiments, or examples, for implementing different features of the invention. Specific examples of components and arrangements are described below to simplify the present disclosure. These are, Note that merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples.

Specific embodiments of the invention for display panels, methods for forming the same, and display systems are described. It is noted that the concepts of the invention can be applied to any known or newly developed display panel, method for forming the same, and display system.

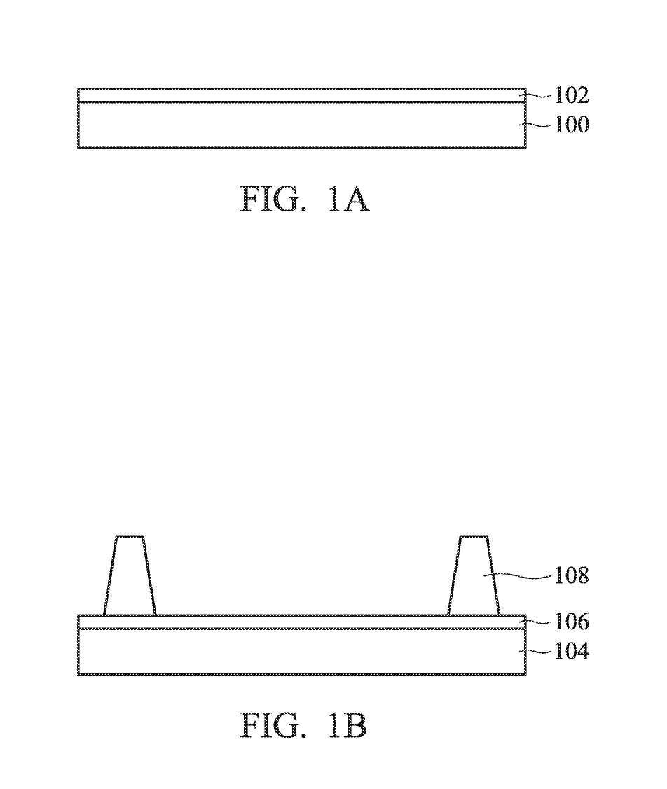

FIGS. 1A through 1C show cross-sections at processing stages of a display panel of an embodiment of the invention. As shown in FIG. 1A, a substrate 100 is provided. The substrate 100 is, for example (but not limited to) a thin film transistor substrate. Next, an alignment layer 102 is formed overlying the substrate 100. In one embodiment, the alignment layer 102 may comprise an alignment material suitable for a rubbing-aligning process.

As shown in FIG. 1B, a substrate 104 is provided. The substrate 104 is, for example (but not limited to) a filter substrate (i.e. color filter substrate). Next, an alignment layer 106 is formed overlying the substrate 104. In one embodiment, the alignment layer 102 may comprise an alignment material suitable for a photo-aligning process. In one embodiment, polarized UV light may be utilized to perform the photo-aligning process on the alignment layer 106. In one embodiment, the material of the alignment layer 106 is different from that of the alignment layer 102. In one embodiment, the thickness of the alignment layer 106 is different from that of the alignment layer 102. In one embodiment, the transmittance of the alignment layer 106 is different from that of the alignment layer 102, and a spacer 108 may be formed overlying the substrate 104.

Next, alignment processes may be performed on the alignment layer 102 and the alignment layer 106, respectively. In one embodiment, a rubbing aligning process may be performed on the alignment layer 102. For example, a rubbing aligning process utilizing a rotation speed between approximately 800 rpm and approximately 1600 rpm may be performed on the alignment layer 102 to form an alignment layer 102R, as shown in FIG. 1C. It is noted that the described rubbing aligning process parameters are merely for example, and can be modified according to requirements without limitation to specific process conditions. In one embodiment, performance of rubbing alignment on the alignment layer 102 may result in better alignment effects, and the alignment may be completed in a shorter period of time.

In one embodiment, a photo-aligning process may be performed on the alignment layer 102. For example, the alignment layer 106 may be illuminated by linearly polarized light with a wavelength from approximately 240 nm to approximately 300 nm, from approximately 280 nm to approximately 330 nm, or from approximately 330 nm to approximately 380 nm under an illumination intensity between approximately 5 mW and 80 mW for a period between approximately 1 second to approximately 200 seconds for alignment to form an alignment layer 106P, as shown in FIG. 1C. It is noted that the described photo-aligning process parameters are merely for example, and can be modified according to requirements without limitation to specific process conditions. In one embodiment, the spacer 108 is disposed overlying the alignment layer 106, and thus, it is possible to precisely align the alignment layer 106 near the bottom of the spacer 108 when performing alignment utilizing the photo-aligning process.

Next, liquid crystal materials can be dropped over the alignment layer 102R or the alignment layer 106P to form a liquid crystal layer 110. The liquid crystal molecules in the liquid crystal materials comprise normal twisted nematic or in-plane switching liquid crystal materials, for example. Next, the substrate 100 and the substrate 104 are assembled, such that the substrate 100 and the substrate 104 are oppositely disposed to sandwich the liquid crystal layer 110 between the alignment layer 102R and the alignment layer 106P, completing the fabrication of the display panel, as shown in FIG. 1C. In one embodiment, a seal layer can be formed at edges of both substrates 100 and 104 to prevent overflow of the liquid crystal materials.

As shown in FIG. 1C, in one embodiment, a first pre-tilt angle of a liquid crystal molecule, which contacts the alignment layer 102R, in the liquid crystal layer 110 is different from a second pre-tilt angle of a liquid crystal molecule, which contacts the alignment layer 106P, in the liquid crystal layer 110. The first pre-tilt angle is between approximately 0 degree and approximately 3 degrees, and the second pre-tilt angle is between approximately 0 degree and approximately 1 degree. The difference between the first pre-tilt angle and the second pre-tilt angle is between approximately 0.5 degree and approximately 2.5 degrees. Alternatively, the difference between the first pre-tilt angle and the second pre-tilt angle can be between approximately 0.5 degree and approximately 1 degree.

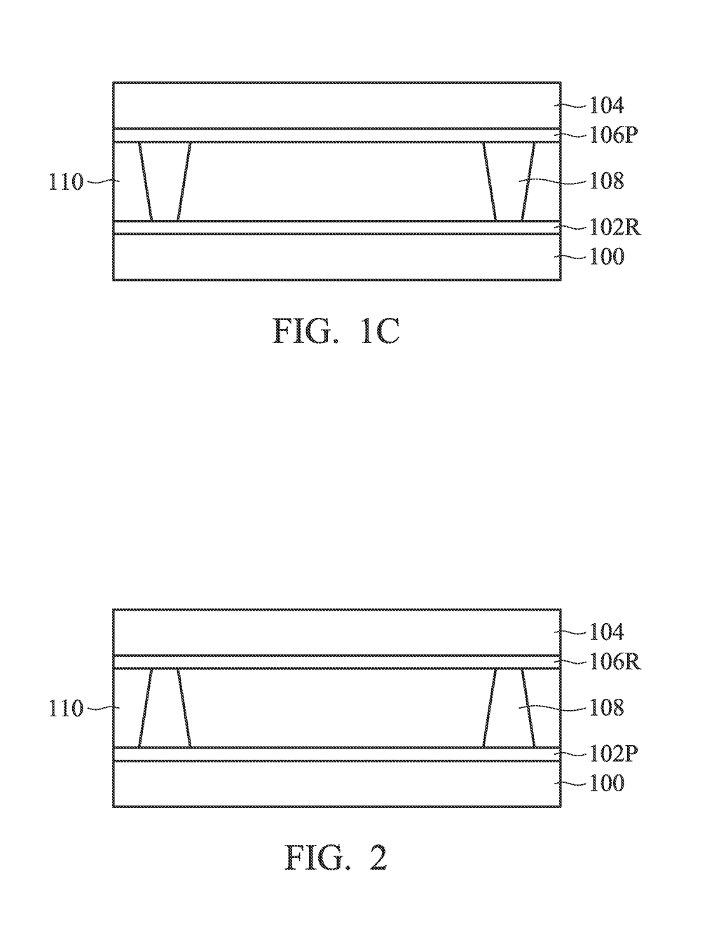

FIG. 2 shows a cross-section a display panel of an embodiment of the invention, wherein the same or similar elements are indicated by the same or similar reference numerals and/or letters. In the embodiment of FIG. 2, the alignment layer overlying the substrate 100 can be the alignment layer 102P aligned by a photo-aligning process, and the alignment layer overlying the substrate 104 can be the alignment layer 106R aligned by rubbing aligning process.

Further, it is noted that the substrate 100 is not limited to the thin film transistor substrate, and the substrate 104 is not limited to the filter substrate. In an another embodiment, the substrate 100 is a filter substrate, and the substrate 104 is a thin film transistor substrate. In a yet another embodiment, the substrate 100 can be a COA (color filter on array) substrate, and the substrate 104 can be a glass substrate. Alternatively, the substrate 104 can be a COA (color filter on array) substrate, and the substrate 100 can be a glass substrate.

In one embodiment, a photo-aligned alignment layer can be formed overlying the substrate with a greater degree of surface altitude difference, and a rubbing aligned alignment layer can be formed overlying the substrate with a lesser degree of surface altitude difference. For example, a protrusion can be disposed overlying the substrate surface, and the protrusion can be between the substrate and the alignment layer. In one embodiment, the protrusion can be a spacer or other features disposed overlying the substrate. In one embodiment, the thickness (or height) of the protrusion is at least greater than or equal to (but not limited to) approximately 2 μm. In one embodiment, a footprint of the protrusion can occupy more than approximately 20% of the unit area, for example, more than approximately 50% of the unit area. In one embodiment, the protrusion is disposed in each of the pixel units, and a ratio of the footprint of the protrusion to an area of a pixel unit is 30% or greater.

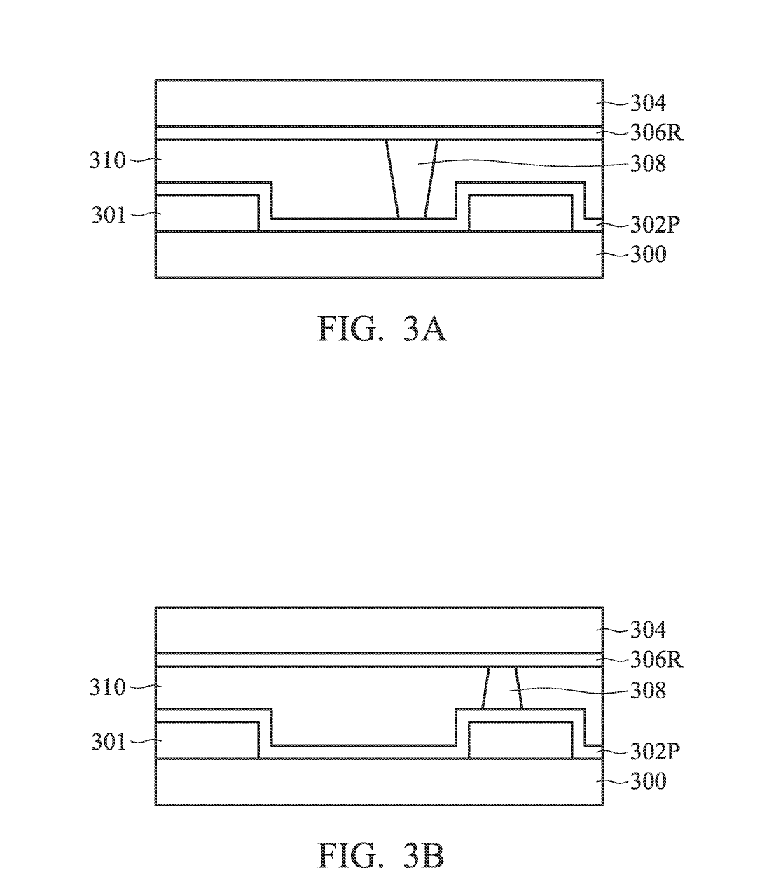

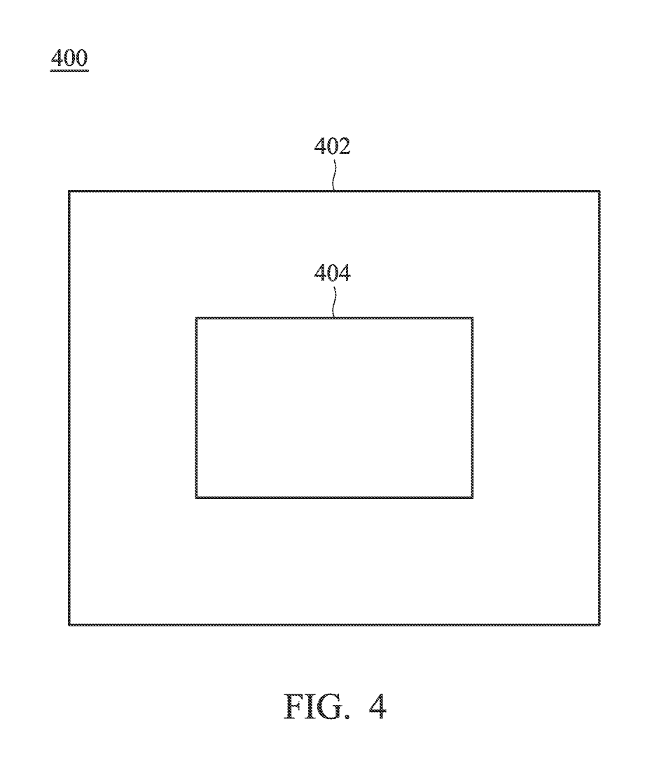

The display panels of the embodiments of the invention can also be applied to transflective display panels. For example, FIG. 3A shows a cross-section a display panel of an embodiment of the invention, wherein the same or similar elements are indicated by the same or similar reference numerals and/or letters.

In the embodiment of FIG. 3A, a protrusion 301 may be formed overlying the substrate 300 for reflecting light. The substrate 300 may comprise a reflection region (the region occupied by the protrusion 301, for example) and a transmission region (the region beyond the reflection region, for example). A spacer 308 may be disposed overlying the alignment layer overlying the substrate 300, and the alignment layer may be aligned by a photo-aligning process to form an alignment layer 302P. Next, a rubbing aligned alignment layer 306R may be formed overlying the substrate 304, and the substrate 304 and the substrate 300 may be oppositely disposed to sandwich a liquid crystal layer 310. In one embodiment, a pixel unit further comprises a transmission region and a reflection region, and a height difference between the light reflection region and the light transmission region is 2 μm or greater.

FIG. 3B shows a cross-section a display panel of an embodiment of the invention, wherein the same or similar elements are indicated by the same or similar reference numerals and/or letters. The embodiment of FIG. 3B is similar to the embodiment of FIG. 3A. In this embodiment, the spacer 308 can be disposed directly above the protrusion 301.

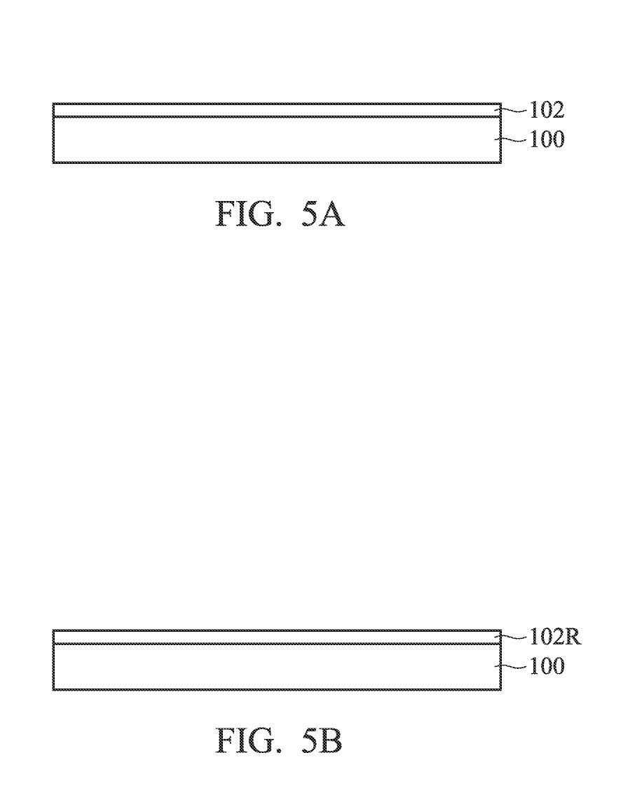

FIG. 4 schematically shows a display system of an embodiment of the invention. As shown in FIG. 4, a display system comprises a display device 402. The display device 402 comprises a display panel 404. The display panel 404 may comprise a structure similar to those shown in FIGS. 1C, 2, 3A or 3B. The display panel 404 may comprise a first substrate, a second substrate disposed opposite to the first substrate, a first alignment layer disposed overlying a surface of the first substrate facing the second substrate, a second alignment layer disposed overlying a surface of the second substrate facing the first substrate, and a liquid crystal layer disposed between the first alignment layer and the second alignment layer, wherein the first alignment layer is rubbing-aligned, and the second alignment layer is photo-aligned. Further, the second substrate can be a thin film transistor substrate where a plurality of thin film transistor elements are disposed. The thin film transistor elements provide a plurality of protrusions 301 for the second substrate, and thus, the second substrate has step height differences.

In the embodiments of the invention, different alignment layers and different aligning processes are utilized at two sides of the liquid crystal, and both the alignment quality can be improved and the process period can be shortened.

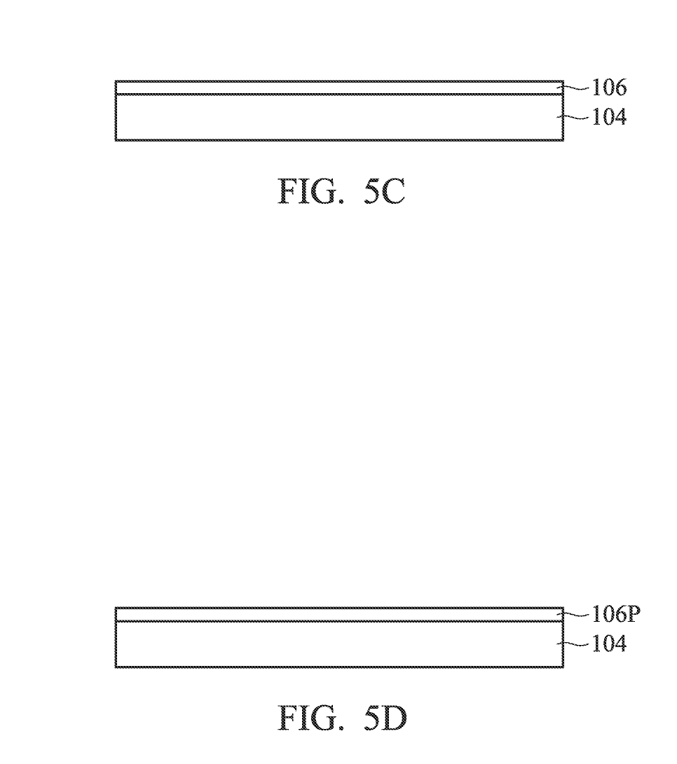

It is possible for the embodiments of the invention to have many other modifications. For example, FIGS. 5A through 5E show cross-sections at processing stages of a display panel of an embodiment of the invention, wherein the same or similar elements are indicated by the same or similar reference numerals and/or letters, which are modified.

As shown in FIG. 5A, a substrate 100 is provided. The substrate 100 is, for example (but not limited to) a filter substrate (i.e. color filter substrate). Next, an alignment layer 102 is formed overlying the substrate 100. In one embodiment, the alignment layer 102 may comprise an alignment material suitable for a rubbing-aligning process. Next, as shown in FIG. 5B, the alignment layer 102 may be aligned by a proper process (similar to or corresponding to the process described in the embodiment of FIG. 1) to form an aligned alignment layer 102R.

As shown in FIG. 5C, a substrate 104 is provided. The substrate 104 is, for example (but not limited to) a thin film transistor substrate. Next, an alignment layer 106 is formed overlying the substrate 104. In one embodiment, the alignment layer 106 may comprise an alignment material suitable for a photo-aligning process. Next, as shown in FIG. 5D, the alignment layer 106 may be aligned by a proper process (similar to or corresponding to the process described in the embodiment of FIG. 1) to form an aligned alignment layer 106P.

Next, as shown in FIG. 5E, a spacer 108′ is formed by a spacer inkjet. Next, liquid crystal materials may be dropped over the alignment layer 102R or the alignment layer 106P. For example, a liquid crystal layer 110 may be formed by one drop filling (ODF). Next, the substrate 100 and the substrate 104 are assembled, such that the substrate 100 and the substrate 104 are oppositely disposed to sandwich the liquid crystal layer 110 between the alignment layer 102R and the alignment layer 106P, completing the fabrication of the display panel, as shown in FIG. 5E. In one embodiment, a seal layer can be formed at edges of both substrates 100 and 104 to prevent overflow of the liquid crystal materials. In the embodiment shown in FIGS. 5A through 5E, the rubbing alignment and photo-alignment processes on the respective alignment layers are completed prior to the forming of the spacer 108′ to prevent the aligning processes from the affection caused by the spacer 108′, thereby making the aligning processes smoother.

It is noted that the embodiments of the invention are not limited to the aforementioned. In other embodiments, it is possible to form the spacer 108′ overlying the alignment first, followed by the rubbing aligning process or photo-aligning process.

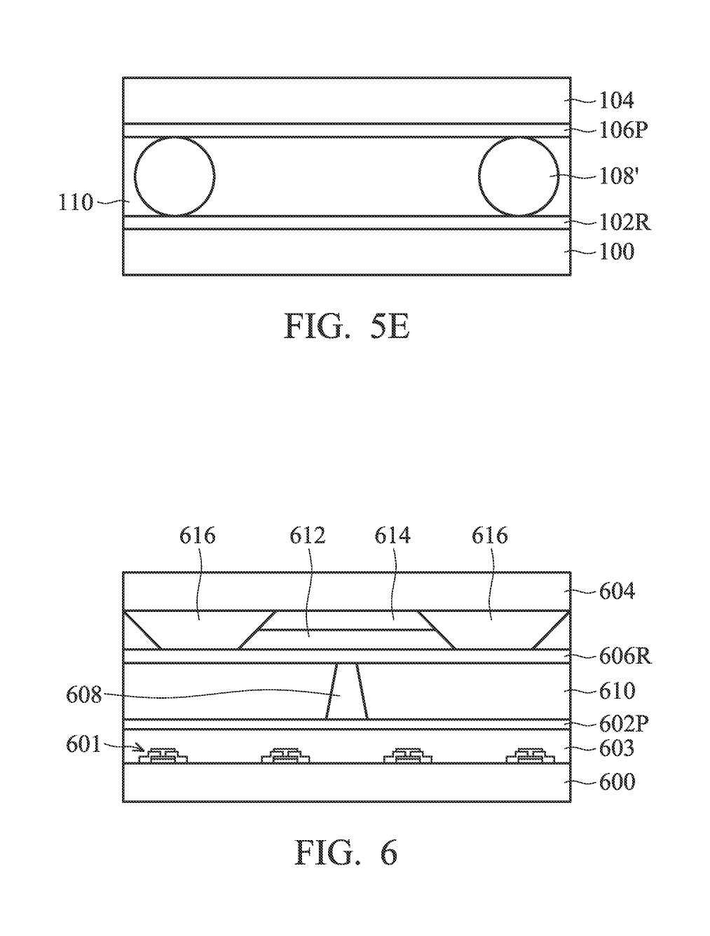

FIG. 6 shows a cross-section a display panel of an embodiment of the invention, wherein the same or similar elements are indicated by the same or similar reference numerals and/or letters. In this embodiment, a protrusion 601 such as a thin film transistor element is disposed overlying the substrate 600. In one embodiment, a planarization layer 603 may be formed overlying the substrate 600 for subsequent processing steps. Thus, the substrate 600 can be a thin film transistor substrate and have greater altitude difference. A filter layer 616, a black matrix 614 and an over coating 612 may be disposed overlying the substrate 604. Thus, the substrate 604 can be a filter substrate, such as a color filter substrate.

Prior to disposing of the substrate 200 and the substrate 604, alignment layers may be, respectively formed overlying the substrate 600 and the substrate 400, followed by the aligning of the alignment layers to form the alignment layer 602P and the alignment layer 606R. In one embodiment, the alignment layer 602P is formed by photo-alignment, and the alignment layer 606R is formed by rubbing alignment, wherein the substrate utilizing the photo-aligned alignment layer 602 may be a thin film transistor substrate where a plurality of thin film transistor elements are disposed.

In one embodiment, a spacer 608 may be formed overlying the alignment layer 602P or the alignment layer 606R. Next, the substrate 100 and the substrate 104 are assembled, such that the substrate 600 and the substrate 604 are oppositely disposed to sandwich the liquid crystal layer 610 between the alignment layer 602R and the alignment layer 606P, completing the fabrication of the display panel, as shown in FIG. 6. In one embodiment, a seal layer can be formed at edges of both substrates 600 and 604 to prevent overflow of the liquid crystal materials.

While the invention has been described by way of example and in terms of preferred embodiment, it is to be understood that the invention is not limited thereto. To the contrary, it is intended to cover various modifications and similar arrangements (as would be apparent to those skilled in the Art). Therefore, the scope of the appended claims should be accorded the broadest interpretation so as to encompass all such modifications and similar arrangements.

What is claimed is:

1. A display panel, comprising:
a first substrate;
a second substrate disposed oppositely to the first substrate;
a first alignment layer disposed overlying the first substrate;
a second alignment layer disposed overlying the second substrate; and
a liquid crystal layer disposed between the first alignment layer and the second alignment layer, wherein
the first alignment layer is rubbing-aligned and disposed between the first substrate and the liquid crystal layer, and
the second alignment layer is photo-aligned and disposed between the second substrate and the liquid crystal layer.

2. The display panel as claimed in claim 1, wherein a first pre-tilt angle of a liquid crystal molecule, which contacts the first alignment layer, in the liquid crystal layer is different from a second pre-tilt angle of a liquid crystal molecule, which contacts the second alignment layer, in the liquid crystal layer.

3. The display panel as claimed in claim 2, wherein the first pre-tilt angle is between approximately 0 degree and approximately 3 degrees, and the second pre-tilt angle is between approximately 0 degree and approximately 1 degree.

4. The display panel as claimed in claim 3, wherein the difference between the first pre-tilt angle and the second pre-tilt angle is between approximately 0.5 degree and approximately 2.5 degrees.

5. The display panel as claimed in claim 2, further comprising a protrusion disposed between the second substrate and the second alignment layer, wherein the thickness of the protrusion is at least 2 μm.

6. The display panel as claimed in claim 5, wherein the second substrate comprises a plurality of pixel units, the protrusion is disposed in each of the pixel units, and a ratio of a footprint of the protrusion to an area of the pixel unit is 30% or greater.

7. The display panel as claimed in claim 6, wherein each pixel unit further comprises a light transmission region and a light reflection region, and a height difference between the light reflection region and the light transmission region is 2 μm or greater.

8. The display panel as claimed in claim 1, further comprising a spacer disposed between the first alignment layer and the second alignment layer.

9. The display panel as claimed in claim 1, wherein the second substrate is a thin film transistor substrate.

10. The display panel as claimed in claim 1, further comprising a planarization layer disposed between the second alignment layer and the second substrate.

11. A display system, comprising:
a display device comprising a display panel, wherein the display panel comprises:
a first substrate;
a second substrate disposed opposite to the first substrate;
a first alignment layer disposed overlying a surface of the first substrate facing the second substrate;
a second alignment layer disposed overlying a surface of the second substrate facing the first substrate; and
a liquid crystal layer disposed between the first alignment layer and the second alignment layer, wherein
the first alignment layer is rubbing-aligned, and
the second alignment layer is photo-aligned.

12. A method for forming a display panel, comprising steps of:
providing a first substrate;
performing a rubbing-aligning process on the first substrate to form a first alignment layer;
providing a second substrate;
performing a photo-aligning process on the second substrate to form a second alignment layer;
forming a liquid crystal layer overlying the first alignment layer or the second alignment layer; and
assembling the first substrate and the second substrate to sandwich the liquid crystal layer between the first alignment layer and the second alignment layer.

13. The method as claimed in claim 12, wherein a surface altitude difference of the second substrate is greater than that of the first substrate.

14. The method as claimed in claim 13, further comprising forming a planarization layer overlying the second substrate prior to forming the second alignment layer overlying the second substrate.

15. The method as claimed in claim 13, wherein a first pre-tilt angle of a liquid crystal molecule, which contacts the first alignment layer, in the liquid crystal layer is different from a second pre-tilt angle of a liquid crystal molecule, which contacts the second alignment layer, in the liquid crystal layer.

16. The method as claimed in claim 15, wherein the first pre-tilt angle is between approximately 0 degree and approximately 3 degrees, and the second pre-tilt angle is between approximately 0 degree and approximately 1 degree.

17. The method as claimed in claim 16, wherein the difference between the first pre-tilt angle and the second pre-tilt angle is between approximately 0.5 degree and approximately 2.5 degrees.

18. The method as claimed in claim 12, further comprising forming a protrusion overlying the second substrate prior to forming the second alignment layer, wherein the height of the protrusion is at least 2 μm.

19. The method as claimed in claim 13, wherein the second substrate is a thin film transistor substrate.

20. The method as claimed in claim 12, further comprising forming a spacer between the first alignment layer and the second alignment layer.
